(19) United States
(12) Patent Application Publication
(10) Pub. No.: US 2022/0350202 A1
(43) Pub. Date: Nov. 3, 2022

(54) SURFACE LIGHT SOURCE DEVICE AND DISPLAY DEVICE

(71) Applicant: Enplas Corporation, Saitama (JP)

(72) Inventor: Hiroshi TAKATORI, Saitama (JP)

(21) Appl. No.: 17/730,113

(22) Filed: Apr. 26, 2022

(30) Foreign Application Priority Data
Apr. 30, 2021 (JP) 2021-077852

(51) Int. Cl. G02F 1/13357

(52) U.S. Cl. CPC G02F 1/133606; G02F 1/133603

(57) ABSTRACT

A surface light source device includes a plurality of light emitting devices each including at least one light emitting element and a light flux controlling member for controlling a distribution of light emitted from the at least one light emitting element; and an optical sheet including a light diffusion member which includes optically transparent particles and which is for transmitting light emitted from the plurality of light emitting devices while diffusing the light. When the number average particle diameter of the particles is A (μm) and the proportion of particles in the light diffusion member is B (wt %), the surface light source device satisfies the formula 0.4≤A≤10 and the formula 0.4647A+0.2169≤B≤2.3119A+2.5103.

### CROSS REFERENCE TO RELATED APPLICATIONS

This application is entitled to the benefit of Japanese Patent Application No. 2021-077852, filed on Apr. 30, 2021, the disclosure of which including the specification, drawings and abstract is incorporated herein by reference in its entirety.

### TECHNICAL FIELD

The present invention relates to a surface light source device and a display device.

### BACKGROUND ART

In recent years, a direct surface light source device including a plurality of light emitting elements as a light source is used in transmission image display devices such as liquid crystal display devices. A large number of light emitting elements may be disposed to illuminate a wide range with light in such a direct surface light source device (see, for example, Patent Literature (hereinafter, referred to as PTL) 1).

PTL 1 discloses a backlight module including a plurality of light sources and a light diffusion plate. The light diffusion plate includes a substrate, whose surface serves as an optical lens, and a diffusion layer disposed on the optical lens. The substrate includes a plurality of protrusions formed on its surface opposite to the other surface that faces the light sources. The diffusion layer is disposed on the substrate in such a way that the surface of the diffusion layer forms protrusions, following the plurality of protrusions of the substrate. In the backlight module disclosed in PTL 1, light emitted from the plurality of light sources is uniformly emitted by the light diffusion plate.

### CITATION LIST

### Patent Literature

PTL 1
Japanese Patent Application Laid-Open No. 2007-188031

### SUMMARY OF INVENTION

### Technical Problem

For the surface light source device (backlight module) which includes the light diffusion plate as disclosed in PTL 1, it is conceivable to dispose a plurality of light flux controlling members for controlling the distribution of light emitted from respective light sources between the plurality of light sources (for example, light emitting diodes) and the light diffusion plate. However, when a plurality of light flux controlling member are disposed, light emitted from one light flux controlling member repeatedly enters the other light flux controlling members, and the light emitted from this light source may propagate through a plurality of light flux controlling members. Such propagation of light through the plurality of light flux controlling members may cause luminance unevenness in the luminance distribution on the surface light source device (backlight module).

An object of the present invention is to provide a surface light source device capable of reducing luminance unevenness even with a plurality of light flux controlling members. Another object of the present invention is to provide a display device that includes the surface light source device.

### Solution to Problem

A surface light source device according to an embodiment of the present invention includes: a plurality of light emitting devices each including one or more light emitting elements and a light flux controlling member for controlling a distribution of light emitted from the one or more light emitting elements; and an optical sheet including a light diffusion member that includes particles having an optical transparency, the light diffusion member being for transmitting light emitted from the plurality of light emitting devices while diffusing the light, in which when a number average particle diameter of the particles is A (μm) and a proportion of the particles in the light diffusion member is B (wt %), the surface light source device satisfies the following Formulas 1 and 2

0.4≤A≤10 Formula 1, and

0.4647A+0.2169≤B≤2.3119A+2.5103 Formula 2.

A display device according to an embodiment of the present invention includes the surface light source device of the present invention and a display member to be illuminated by light emitted from the surface light source device.

### Advantageous Effects of Invention

The present invention can provide a surface light source device capable of reducing luminance unevenness even with a plurality of light flux controlling members. The present invention can also provide a display device including the surface light source device.

### BRIEF DESCRIPTION OF DRAWINGS

FIGS. 1A and 1B illustrate a configuration of a surface light source device according to embodiment 1 of the present invention;

FIGS. 2A and 2B also illustrate the configuration of the surface light source device according to embodiment 1 of the present invention;

FIG. 3 is a partially enlarged cross-sectional view illustrating an enlarged part of FIG. 2B;

FIGS. 4A and 4B illustrate a configuration of a light flux controlling member in embodiment 1 of the present invention;

FIGS. 5A to 5C are perspective views illustrating an example of a light diffusion member;

FIG. 6 is a schematic diagram for explaining the conditions of simulation 1;

FIGS. 7A to 7C illustrate enhancement in luminance unevenness (herein also referred to as “luminance unevenness enhancement”);

FIGS. 8A to 8C are graphs each showing the distance from the center of gravity of a light emitting device and the luminance unevenness enhancement;

FIG. 9 is a graph showing the distance from the center of gravity of the light emitting device and the difference in luminance unevenness enhancement;

FIGS. 10A and 10B are schematic diagrams for explaining the conditions of simulation 2;

FIGS. 11A and 11B illustrate luminance distributions on light diffusing members;

FIGS. 12A and 12B illustrate the partially enlarged luminance distributions of FIGS. 11A and 11B;

FIGS. 13A and 13B are graphs showing first derivative values (first-order differential values) of FIGS. 12A and 12B;

FIGS. 14A and 14B are graphs each showing the relationship between the proportion of particles in the light diffusion member and the first derivative value of FIGS. 12A and 12B;

FIGS. 15A and 15B are graphs each also showing the relationship between the proportion of particles in the light diffusion member and the first derivative value of FIGS. 12A and 12B;

FIG. 16 is a graph showing the relationship between the number average particle diameter of particles and the proportion of particles in the light diffusion member;

FIGS. 17A and 17B are cross-sectional views of a surface light source device in embodiment 2 of the present invention;

FIGS. 18A to 18D illustrate a configuration of a light flux controlling member in embodiment 2 of the present invention; and

FIG. 19 is a table for explaining the relationship between the luminance distribution and the distance from a substrate to a light diffusion member with respect to the distance between light emitting devices.

### DESCRIPTION OF EMBODIMENTS

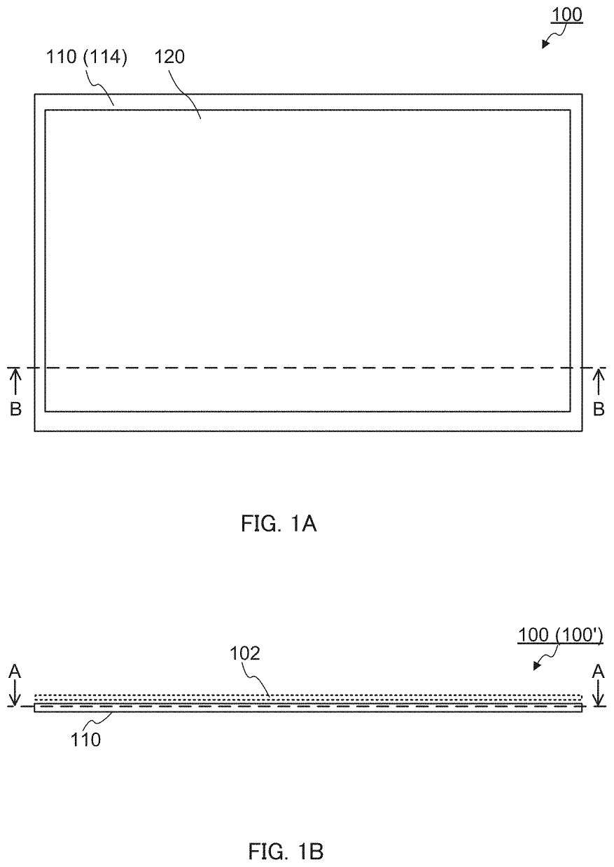

Hereinafter, one or more embodiments of the present invention will be described in detail with reference to the drawings. In the following description, surface light source devices suitable for backlights of liquid crystal display devices or the like will be described as a typical example of the surface light source device according to the present invention. These surface light source devices each can be used as display device 100′ in combination with display member 102 (such as a liquid crystal panel) which is to be illuminated with light from the surface light source device (see FIG. 1B).

### Embodiment 1

Configurations of Surface Light Source Device and Light Emitting Device

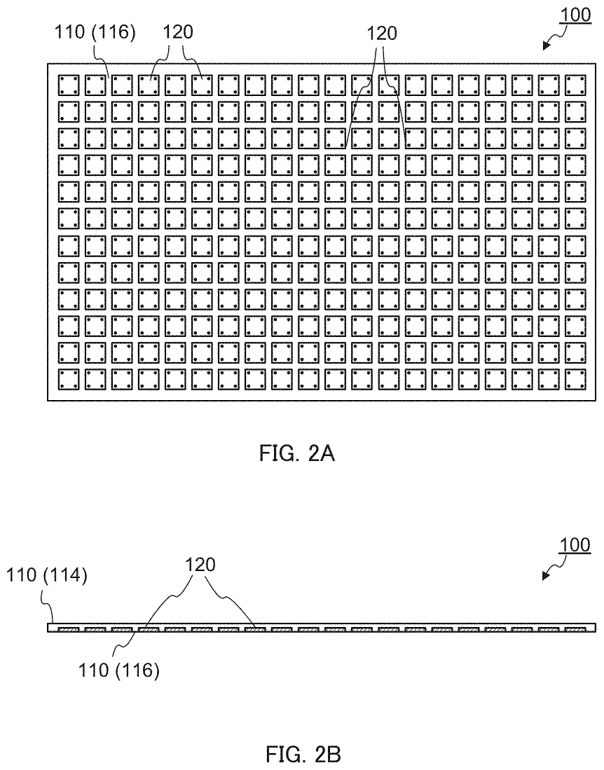

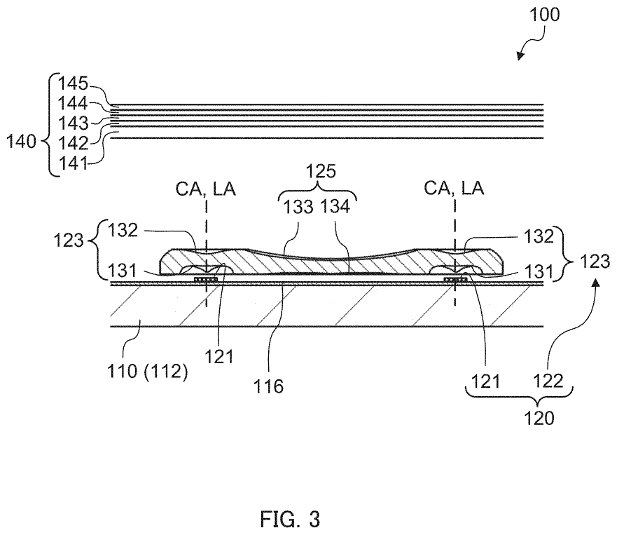

FIGS. 1A, 1B, 2A, 2B, and 3 illustrate a configuration of surface light source device 100 according to embodiment 1 of the present invention. FIG. 1A is plan view and FIG. 1B is a front view of surface light source device 100. FIG. 2A is a cross-sectional view taken along line A-A of FIG. 1B, and FIG. 2B is a cross-sectional view taken along line B-B of FIG. 1A. FIG. 3 is a partially enlarged cross-sectional view illustrating an enlarged part of FIG. 2B.

As illustrated in FIGS. 1A, 1B, 2A, 2B, and 3, surface light source device 100 according to the present embodiment includes casing 110, plurality of light emitting devices 120, and optical sheet 140 including light diffusion member 141. In the present embodiment, light diffusion member 141 is disposed at the position closest to light emitting device 120. Plurality of light emitting devices 120 are disposed on substrate 116 that is disposed on bottom plate 112 of casing 110. A reflective sheet may be disposed on the surface of bottom plate 112 or substrate 116, and the surface of the reflective sheet may function as a diffusive reflection surface. Alternatively, the surface of bottom plate 112 or substrate 116 may function as the diffusive reflection surface. In the present embodiment, the surface of substrate 116 functions as the diffusive reflection surface. Top plate 114 of casing 110 is provided with an opening. Optical sheet 140 is disposed to close the opening, and functions as a light emitting surface. The light emitting surface may have any size which is, for example, about 400 mm× about 700 mm

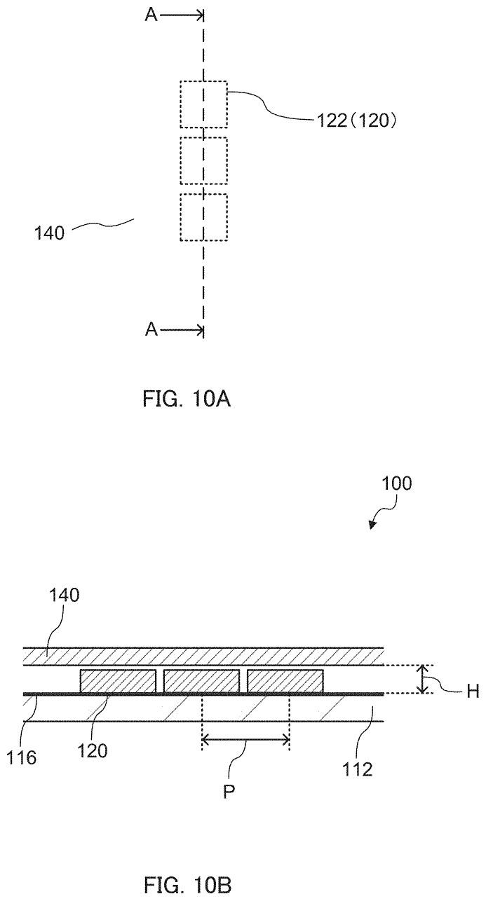

Distance H (see FIG. 10B) between the front surface of substrate 116 and the back surface of light diffusion member 141 changes depending on the shape of light flux controlling member 122 in plan view and the number of light emitting elements 121. In the present embodiment, as described below, distance H between the front surface of substrate 116 and the back surface of light diffusion member 141 is preferably 2 to 5 mm, more preferably 2 to 3 mm, as the shape of light flux controlling member 122 in plan view is substantially rectangular, and the number of light emitting elements 121 is more than one.

As illustrated in FIG. 3, plurality of light emitting devices 120 are fixed on substrate 116. Substrate 116 is fixed at a predetermined position on bottom plate 112 of casing 110. Each light emitting device 120 includes at least one light emitting element 121 and light flux controlling member 122. In the present embodiment, the legs are omitted. As light flux controlling member 122 includes at last one leg, a gap for releasing the heat generated by light emitting element 121 to the outside is formed between substrate 116 with light emitting elements 121 mounted thereon and the back surface of light flux controlling member 122 (see FIG. 3).

Plurality of light emitting devices 120 are disposed in such a way that the center of each light emitting device is superposed on a grid point of a quadrangle grid (in a matrix). In the first direction along one side of the quadrangle grid, the distance between the centers of gravity of two adjacent light emitting devices 120 is, for example, in the range of 16 to 30 mm. In the present embodiment, the distance between the centers of gravity of light emitting devices 120 in the first direction is about 23 to 24 mm. In the second direction orthogonal to the first direction, the distance between the centers of gravity of two adjacent light emitting devices 120 is, for example, in the range of 16 to 30 mm. In the present embodiment, the distance between the centers of gravity of light emitting devices 120 in the second direction is about 23 to 24 mm. When distance P between the centers of gravity is short in the first direction and the second direction, the number of light emitting devices 120 increases, which may increase the manufacturing cost. When distance P between the centers of gravity is long, meanwhile, it may not be possible to uniformly illuminate the display member by light. Herein, the distance between the centers of gravity of light emitting devices 120 means the distance between the centers of gravity of two adjacent light emitting devices 120 when plurality of light emitting devices 120 are viewed in plan view.

As described below, it is preferable that distance P (mm) (i.e., distance between the centers of gravity of two adjacent light emitting devices 120 among the plurality of light emitting devices 120) and distance H (mm) (i.e., distance between the front surface of substrate 116 and the back surface of light diffusion member 141) satisfy the following Formula 4.

0.08≤H/P≤0.22 Formula 4

When this condition is satisfied, the effect of optical sheet 140 (light diffusion member 141) is increased. The lower limit value of H/P is the minimum value with the thickness of light emitting device 120 taken into consideration. The upper limit value of H/P will be described below.

Light emitting elements 121 are light sources of surface light source device 100 and are mounted in a grid pattern (in a matrix) on substrate 116. Light emitting element 121 is, for example, a light emitting diode (LED) such as a blue light emitting diode, a white light emitting diode, or an RGB light emitting diode. Light emitting element 121 may be of any type, and light emitting element 121 (for example, COB type light emitting diode) which emits light from the top surface and side surface(s) is suitably used in light emitting device 120 according to the present embodiment. The length of one side of light emitting element 121 is not limited, which is preferably in the range of 0.1 to 0.6 mm, and more preferably in the range of 0.1 to 0.3 mm. In the present invention, using a smaller LED can obtain more appropriate light distribution, thereby making obtainment of an optical controlling member having less luminance unevenness possible. For example, the size of light emitting element 121 is 0.2 mm×0.38 mm

Configuration of Light Flux Controlling Member

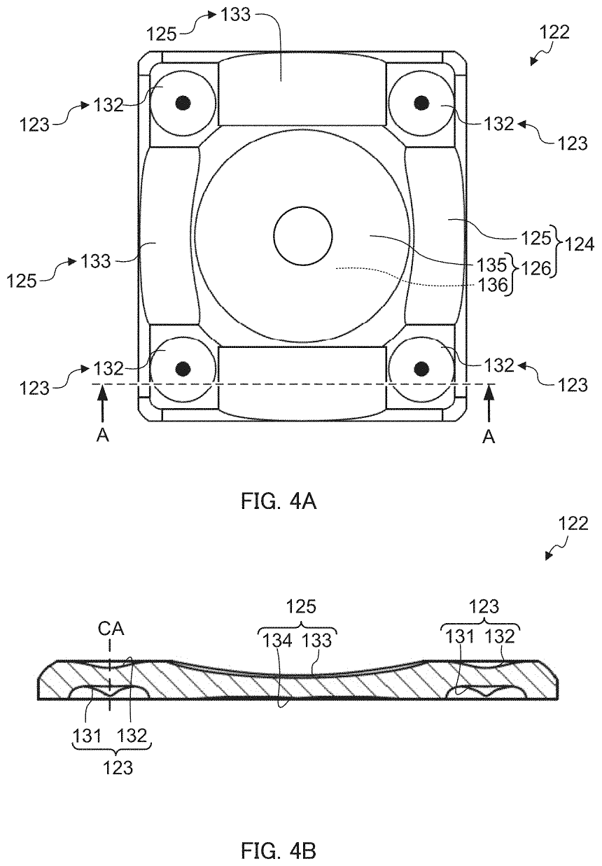

FIGS. 4A and 4B illustrate a configuration of light flux controlling member 122 in embodiment 1 of the present invention. FIG. 4A is a plan view of light flux controlling member 122. FIG. 4B is a cross-sectional view taken along line A-A of FIG. 4A.

As illustrated in FIGS. 3, 4A, and 4B, light flux controlling member 122 is an optical member configured to controls the distribution of light emitted from light emitting element 121, and is fixed on substrate 116. Light flux controlling member 122 includes a plurality of incidence units 123 and emission unit 124. Light flux controlling member 122 is disposed above a plurality of light emitting elements 121 in such a way that central axis CA of each incidence unit 123 (incidence surface 131) coincides with optical axis OA of corresponding light emitting element 121. In light flux controlling member 122 according to the present embodiment, incidence unit 123 (incidence surface 131 and reflection surface 132) of light flux controlling member 122 is rotationally symmetric. The rotation axis of incidence unit 123 is referred to as “central axis CA of incidence unit 123, incidence surface 131, or reflection surface 132.” In addition, “optical axis OA of light emitting element 121” means a central light beam of a stereoscopic emission light flux from light emitting element 121. A gap for releasing the heat generated from light emitting element 121 to the outside may or may not be formed between substrate 116 with light emitting element 121 mounted thereon and the back surface of light flux controlling member 122. In the present embodiment, a gap for releasing the heat generated from light emitting element 121 to the outside is formed between substrate 116 with light emitting element 121 mounted thereon and the back surface of light flux controlling member 122.

Light flux controlling member 122 is formed by integral molding. The material of light flux controlling member 122 is for example, an optically transparent resin that allows light with a desired wavelength to pass therethrough, or glass. Examples of the optically transparent resin include polymethylmethacrylate (PMMA), polycarbonates (PC), and epoxy resins (EP). Light flux controlling member 122 may have any shape in plan view. The shape of light flux controlling member 122 in plan view may be circular, elliptical, or polygonal. When light flux controlling member 122 has a polygonal shape in plan view, the light flux controlling member may have a substantially polygonal shape with chamfered corners. In the present embodiment, the shape of light flux controlling member 122 in plan view is a substantially square (substantially rectangular) shape with chamfered corners.

Each incidence unit 123 allows thereon incidence of light emitted from corresponding light emitting element 121. Incidence unit 123 includes incidence surface 131 that allows thereon incidence of light emitted from light emitting element 121, and reflection surface 132 that reflects the light incident on incidence surface 131 toward emission unit 124.

Incidence surface 131 is disposed on the back side of light flux controlling member 122 and is an inner surface of a recess formed at a position facing light emitting element 121. Incidence surface 131 allows the majority of light emitted from light emitting element 121 to enter light flux controlling member 122, while controlling the travelling direction of the light. Incidence surface 131 intersects optical axis OA of light emitting element 121 and is rotationally symmetric (circular symmetric) about optical axis OA. Incidence surface 131 may have any shape which is set in such a way that the light incident on incidence surface 131 is directed to reflection surface 132, first emission surface 133, and third emission surface 135. In the present embodiment, incidence surface 131 has a shape such that as the distance to the surface from optical axis OA of light emitting element 121 increases, the distance to the surface from substrate 116 gradually increases and then gradually decreases.

Reflection surface 132 is disposed on the front side of light flux controlling member 122 at a position facing light emitting element 121 with incidence surface 131 placed between the reflection surface and the light emitting element. Reflection surface 132 laterally reflects the light incident on incidence surface 131 in such a way that the reflected light travels away from optical axis OA of light emitting element 121. Herein, “laterally” does not mean a direction toward the outer edge of the light flux controlling member 122, but means any direction directed outward in the radial direction 360° about central axis CA.

Reflection surface 132 configured as described above thus can prevent light incident on incidence surface 131 from escaping upward, thereby preventing the generation of a bright part immediately above light emitting element 121, and can also guide the light between light emitting elements 121, thereby preventing the generation of a dark part between light emitting elements 121. Reflection surface 132 may have any shape as long as the light having entered from incidence surface 131 is laterally reflected. Reflection surface 132 may be configured, for example, to be rotationally symmetric (circularly symmetric) about optical axis OA of light emitting element 121, and to approach the front side (away from substrate 116) as the distance to the surface from optical axis OA of light emitting element 121 increases.

The generatrix from the central portion to the outer peripheral portion of this rotationally symmetric surface is a curved line or a straight line inclined with respect to optical axis OA of light emitting element 121. Reflection surface 132 is a concave surface in a state obtained by rotating the generatrix by 360° with central axis CA of incidence surface 131 as a rotation axis. In the present embodiment, the generatrix is a straight line.

Emission unit 124 emits light incident on plurality of incidence units 123 while guiding the light. In the present embodiment, emission unit 124 includes at least one first emission unit 125 disposed on the outer peripheral portion of light flux controlling member 122 and second emission unit 126 disposed in the center of light flux controlling member 122. Emission unit 124 includes an emission promotion part for promoting the emission of light having reached first emission unit 125 and second emission unit 126.

First emission unit 125 includes first emission surface 133 disposed on the front surface of light flux controlling member 122, and second emission surface 134 disposed on the back surface of light flux controlling member 122.

First emission surface 133 may have any shape. In the present embodiment, first emission surface 133 is a concave surface having a curvature in the first direction along one side of light flux controlling member 122 and no curvature in the second direction perpendicular to this side.

Second emission surface 134 may have any shape. In the present embodiment, second emission surface 134 has a shape of the inner surface of two recesses each having a substantially trapezoidal shape in a cross section that includes central axes CA of two incidence surfaces 131 disposed at adjacent corners.

Second emission unit 126 includes third emission surface 135 disposed on the front surface of light flux controlling member 122, and fourth emission surface 136 disposed on the back surface of light flux controlling member 122.

Third emission surface 135 may have any shape. In the present embodiment, third emission surface 135 is a concave surface composed of the upper bottom and a part of the side surface of a truncated cone disposed upside down.

Fourth emission surface 136 may have any shape. In the present embodiment, fourth emission surface 136 is a flat surface.

The emission promotion part may have any configuration as long as the above function can be obtained. An emission promotion part is disposed, for example, at first emission unit 125 or second emission unit 126. The emission promotion part of first emission unit 125 may be at least one selected from the group consisting of concave surfaces, rough surfaces, fresnel surfaces, grooves, and through holes, which is disposed on, for example, at least one of first emission surface 133 and second emission surface 134. The emission promotion part of second emission unit 126 may be at least one selected from the group consisting of concave surfaces, rough surfaces, fresnel surfaces, grooves, and through holes, which is disposed on, for example, at least one of third emission surface 135 and fourth emission surface 136.

Optical sheet 140 includes light diffusion member 141. Optical sheet 140 may have any configuration as long as the optical sheet includes light diffusion member 141. Optical sheet 140 may be composed of one sheet-shaped member or a plurality of sheet-shaped members. In the present embodiment, optical sheet 140 is composed of a plurality of sheet-shaped members. Specifically, in the present embodiment, optical sheet 140 includes light diffusion member 141, quantum dot sheet 142, first prism sheet 143, second prism sheet 144, and a dual brightness enhancement film (DBEF (Registered trademark)) 145 in this order from the light emitting device 120 side. Another example of the sheet-shaped member of optical sheet 140 is a laminate of light diffusion member 141 and prism sheets 143 and 144. Normally, the size of optical sheet 140 is substantially the same as that of the display member such as a liquid crystal panel.

Light diffusion plate 141 is a plate-shaped member having a light diffusing property, and configured to transmit light emitted from light emitting device 120 while diffusing the light. Light diffusion plate 141 is formed of, for example, an optically transparent resin such as polymethylmethacrylate (PMMA), a polycarbonate (PC), polystyrene (PS), or a styrene-methylmethacrylate copolymer resin (MS). For imparting the light diffusing property, light diffusion member 141 contains optically transparent particles in its inside. In addition, light diffusion member 141 may have fine irregularities formed on its surface. In the present embodiment, light diffusion member 141 contains optically transparent particles, and have a plurality of protrusions on its surface.

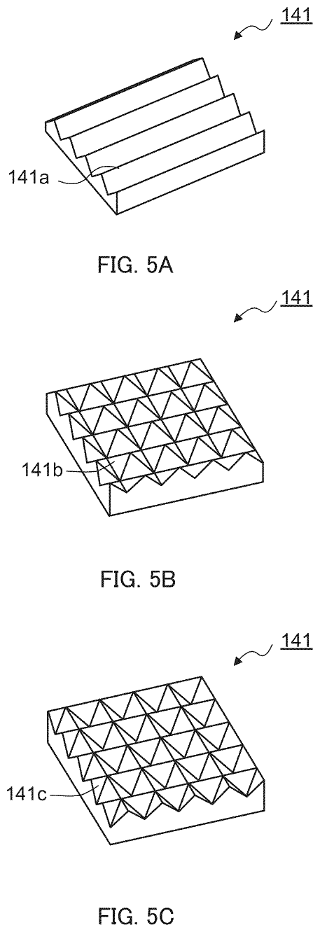

FIGS. 5A to 5C are diagrams for explaining linear protrusions, protrusions, or recesses of light diffusion member 141. FIG. 5A is a perspective view illustrating the surface structure of light diffusion member 141 including plurality of linear protrusions 141a;

FIG. 5B is a perspective view illustrating the surface structure of light diffusion member 141 including plurality of protrusions 141b; and FIG. 5C is a perspective view illustrating the surface structure of light diffusion member 141 including plurality of recesses 141c.

Light diffusion member 141 may include plurality of linear protrusions 141a as illustrated in FIG. 5A, plurality of protrusions 141b as illustrated in FIG. 5B, or plurality of recesses 141c as illustrated in FIG. 5C. Plurality of linear protrusions 141a, plurality of protrusions 141b, or plurality of recesses 141c are disposed on the surface (back surface) of light diffusion member 141, the surface on the light flux controlling member 122 side.

Linear protrusions 141a may be the same or different from each other in the size thereof. In the present embodiment, linear protrusions 141a have the same size. Linear protrusions 141a may be disposed without gaps from each other, or may be disposed apart from each other. In the present embodiment, linear protrusions 141a are disposed without gaps from each other. Linear protrusions 141a being disposed without gaps from each other allows a large proportion of light emitted from light emitting device 120 to be incident on light diffusion member 141. Further, light emitted from light emitting device 120 can be refracted and condensed. When linear protrusions 141a are disposed apart from each other, a flat surface is formed between adjacent linear protrusions 141a.

Protrusions 141b or recesses 141c may be the same or different from each other in the size thereof. In the present embodiment, protrusions 141b have the same size, and recesses 141c have the same size. The number of protrusions 141b or recesses 141c is set based on the size of the light emitting surface of surface light source device 100 and the size of protrusions 141b or recesses 141c. Protrusions 141b or recesses 141c may be disposed without gaps from each other, or may be disposed apart from each other. In the present embodiment, protrusions 141b or recesses 141c are disposed without gaps. Protrusions 141b or recesses 141c being disposed without gaps from each other allows a large proportion of light emitted from light emitting device 120 to be incident on light diffusion member 141. Further, light emitted from light emitting device 120 can be refracted and condensed. When protrusions 141b or recesses 141c are disposed apart from each other, a flat surface is formed between adjacent protrusions 141b or recesses 141c. In the present embodiment, protrusion 141b and recess 141c each has a shape of a quadrangular pyramid.

The particles may be of any type as long as the particle are optically transparent. Examples of optically transparent particles include silicone particles, silica particles, and melamine-formaldehyde condensate particles. Silicone particles are preferred from the viewpoint of uniformly dispersing the particles in a optically transparent resin that forms light diffusion member 141. The number average particle diameter of the particles is preferably in the range of 0.4 to 10 μm.

The proportion of particles (herein also referred to as “particle proportion”) relative to light diffusion member 141 is set according to the number average particle diameter of the particles. When the number average particle diameter of the particles is A (μm) and the proportion of particles in light diffusion member 141 is B (wt %), the following Formulas 1 and 2 are satisfied.

0.4≤A≤10 Formula 1

0.4647A+0.2169≤B≤2.3119A+2.5103 Formula 2

It is more preferable that the relationship between A and B satisfies the following Formula 3.

0.4647A+0.5353≤B≤2.3119A+0.8762 Formula 3

As the details of the above Formulas 1, 2, and 3 will be described below, satisfying at least the above Formulas 1 and 2 can prevent the occurrence of luminance unevenness.

Known examples of commercially available particles include silicone particles (TSR9500 with number average particle diameter of 4.5 μm, and XC99-A8808 with number average particle diameter of 0.7 μm, from Momentive Performance Materials Japan LLC), melamine-formaldehyde condensate particles (S6 with number average particle diameter of 0.4 μm, from NIPPON SHOKUBAI Co., Ltd.), and silica particles (KE-P with number average particle diameter of 0.3 μm, from NIPPON SHOKUBAI Co., Ltd.).

Quantum dot sheet 142 is, for example, a sheet-shaped member including the first quantum dots and the second quantum dots, and transmits blue light emitted from light emitting device 120 while converting the light into white light. In the present embodiment, quantum dot sheet 142 includes first quantum dots that convert at least a part of light having a wavelength of 380 to 485 nm into red light having a wavelength of 605 to 780 nm, and second quantum dots that convert at least a part of light having a wavelength of 380 to 485 nm into green light having a wavelength of 500 to 585 nm. Examples of the first quantum dots and the second quantum dots include CdS, CdSe, CdTe, and InP.

In the present embodiment, the first quantum dots and the second quantum dots are used to emit white light. Specifically, the first quantum dots convert at least a part of blue light having a wavelength of 380 to 485 nm into red light having a wavelength between 625 and 780 nm. The second quantum dots convert at least a part of blue light having a wavelength between 380 and 485 nm into green light having a wavelength of 500 to 585 nm. The red light and the green light obtained by the conversion and the blue light passing through optical sheet 140 are combined to emit white light.

First prism sheet 143 includes a plurality of first linear protrusions, and transmits light having reached the sheet while controlling the travelling direction of the light. The first ridgelines of the first linear protrusions are straight lines and disposed so as to be parallel to each other. First linear protrusions may be disposed on the light emitting device 120 side or on the dual brightness enhancement film 145 side.

Second prism sheet 144 includes a plurality of second linear protrusions, and transmits light having reached the sheet while controlling the travelling direction of the light.

The second ridgelines of the second linear protrusions are straight lines and disposed so as to be parallel to each other. Second linear protrusions may be disposed on the light emitting device 120 side or on the dual brightness enhancement film 145 side.

The first ridgeline of the first linear protrusion and the second ridgeline of the second linear protrusion preferably intersect with each other when viewed in plan view.

Dual brightness enhancement film 145 is a reflective polarizing film based on the multilayer thin film technology.

Simulation 1

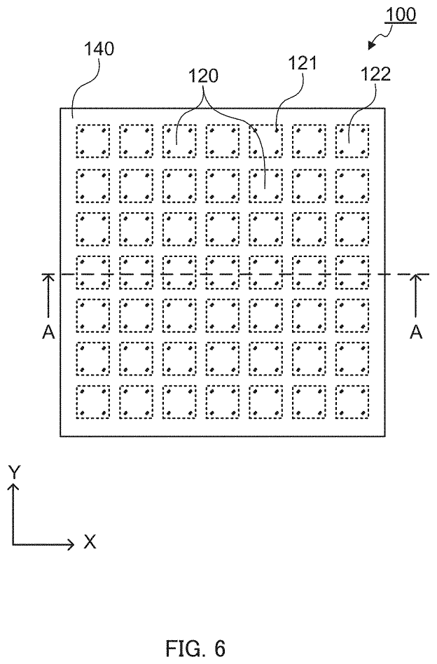

The investigation was made for the relationship between luminance unevenness enhancement and distance H from substrate 116 to light diffusion member 141 with respect to distance P between the centers of gravity of light emitting devices 120. FIG. 6 is a diagram for explaining the measurement conditions of the luminance distribution. In this simulation, only four light emitting elements 121 in one light emitting device 120 disposed in the center in FIG. 6 were turned on. As the light diffusion member for this simulation, light diffusion member 141 satisfying the above Formulas 1 and 2 was used. Light diffusion member 141 has a thickness of 2 mm. The size of one side of light flux controlling member 122 is 9.0 mm. The distance between the centers of gravity of light emitting devices 120 in the X direction of FIG. 6 is 24 mm, and distance P between the centers of gravity of light emitting devices 120 in the Y direction of FIG. 6 is also 24 mm. In addition, distance H between substrate 116 and light diffusing member 141 is 2 mm, 3 mm, or 4 mm. As optical sheet 140, the following were used: light diffusion member 141 described above, quantum dot sheet 142, first prism sheet 143 (BEFIII from 3M Japan Limited), second prism sheet 144 (BEFIII from 3M Japan Limited), and dual brightness enhancement film (DBEF) 450.

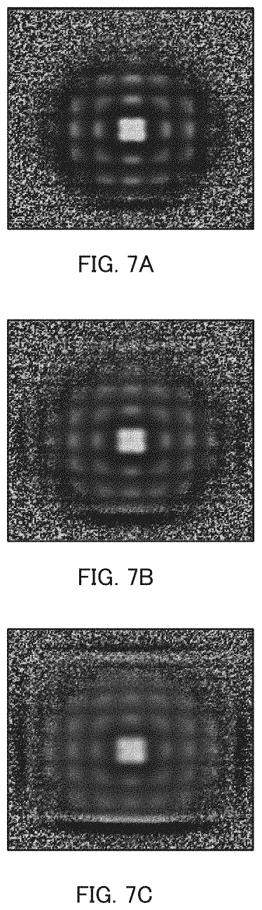

FIGS. 7A to 7C show the distribution of luminance unevenness enhancement for surface light source device 100 with light flux controlling member 122 of the present embodiment. FIG. 7A shows the distribution of luminance unevenness enhancement of surface light source device 100 in which distance H between substrate 116 and optical sheet 140 is 2 mm FIG. 7B shows the distribution of luminance unevenness enhancement of surface light source device 100 in which distance H between substrate 116 and optical sheet 140 is 3 mm FIG. 7C shows the distribution of luminance unevenness enhancement of surface light source device 100 in which distance H between substrate 116 and optical sheet 140 is 4 mm

FIGS. 7A to 7C show that the longer the distance H between substrate 116 and optical sheet 140, the weaker the luminance unevenness enhancement.

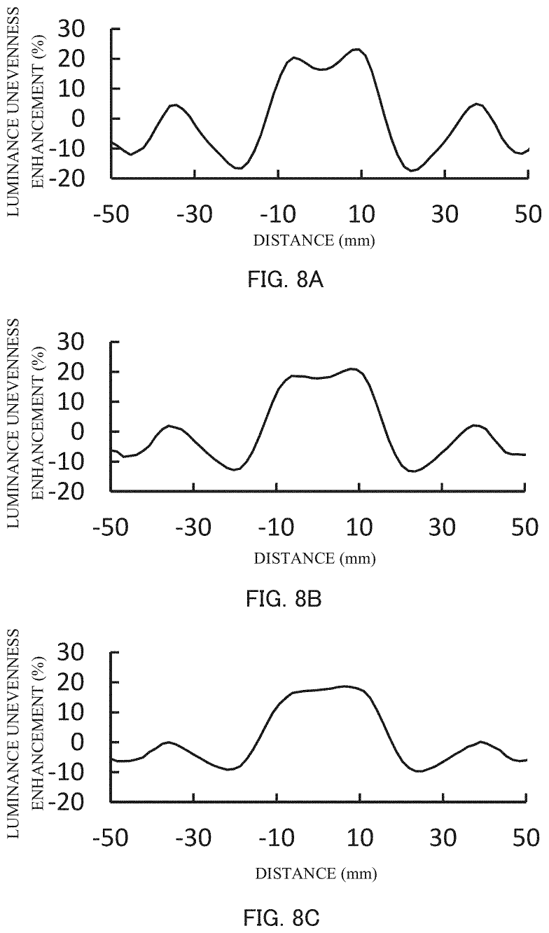

FIGS. 8A to 8C are graphs each showing the luminance unevenness enhancement.

FIG. 8A is a graph showing the luminance unevenness enhancement corresponding to FIG. 7A. FIG. 8B is a graph showing the luminance unevenness enhancement corresponding to FIG. 7B. FIG. 8C is a graph showing the luminance unevenness enhancement corresponding to FIG. 7C. The abscissa of FIGS. 8A to 8C represents distance from the center of gravity of lit light emitting device 120. The ordinate of FIGS. 8A to 8C represents luminance unevenness enhancement (%). The “luminance unevenness enhancement” is a value represented by the formula {(Lva-Lvb)/Lvb}×100 where the luminance of the pixel to be measured is Lva and the average luminance of the surrounding pixels is Lvb. In this simulation, Lvb is the average value of the luminance of 66 pixels (about 2 mm each in the X direction and the Y direction) with the pixel to be measured as the center. FIGS. 8A to 8C show the luminance unevenness enhancement on the line A-A of FIG. 6A.

In FIGS. 8A to 8C, the valleys in the vicinity of +22 mm and −22 mm from the center of gravity of light emitting device 120 with lit light emitting elements 121 (herein also referred to as “lit light emitting device 120”) are each located in a region between lit light emitting device 120 and adjacent light emitting device 120 in surface light source device 100; the mountains in the vicinity of +38 mm and −38 mm from the center of gravity of lit light emitting device 120 each correspond to the vicinity of the side surface of light emitting device 120 adjacent to lit light emitting device 120 on the side far from lit light emitting device 120. Therefore, when the difference in the luminance unevenness enhancement between the mountain and the valley decreases, it can be considered that the luminance unevenness is reduced.

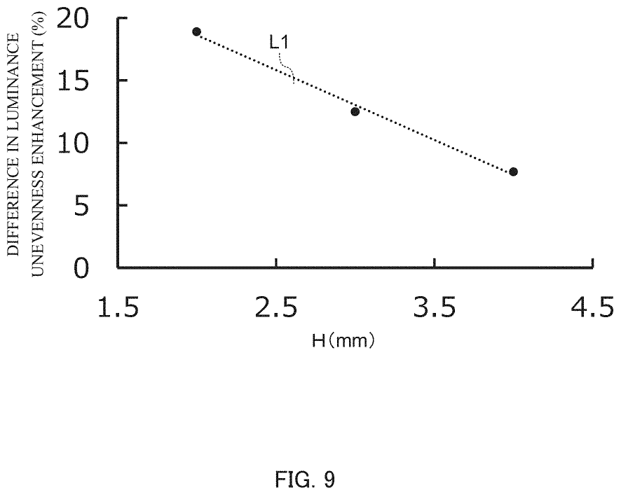

Distance H between substrate 116 and light diffusion member 141, and the difference in luminance unevenness enhancement shown in FIGS. 8A to 8C were then plotted. FIG. 9 is a graph showing the relationship between distance H between substrate 116 and optical sheet 140, and the difference in luminance unevenness enhancement. Straight line L1 illustrated in FIG. 9 is an approximate straight line obtained by the least squares method by using distance H between substrate 116 and light diffusion member 141, and the luminance unevenness enhancement. Straight line L1 can be represented by the formula Y=−5.60000X×29.83333 where distance H between substrate 116 and optical sheet 140 is X and the luminance unevenness enhancement is Y. The “difference in luminance unevenness enhancement” refers to the difference in luminance unevenness enhancement between the valley (in the region between lit light emitting device 120 and adjacent light emitting device 120 in surface light source device 100) and the mountain (in the vicinity of the side surface of light emitting device 120 adjacent to lit light emitting device 120 on the side far from lit light emitting device 120).

FIG. 9 shows that the longer the distance H between substrate 116 and light diffusion member 141, the weaker the luminance unevenness. As described above, when the difference in luminance unevenness enhancement becomes 0, the luminance unevenness does not occur. Distance H between substrate 116 and optical sheet 140 at which luminance unevenness does not occur is found to be about 5.23 mm. As described above, the distance between the centers of gravity is about 24 mm in this simulation, thus the value of H/P capable of obtaining remarkable effects of the present invention is about 0.22 or less.

Simulation 2

The investigation was made for the luminance distribution immediately above light emitting device 120 of surface light source device 100. FIGS. 10A and 10B are schematic diagrams for explaining the conditions of simulation 2. FIG. 10A is a partially enlarged plan view of the device used for measuring the luminance distribution. FIG. 10B is a partially enlarged cross-sectional view taken along line A-A of FIG. 10A.

As illustrated in FIG. 10, the investigation was made for luminance distribution on the line A-A of FIG. 10A when three light emitting devices 120 were disposed in a row and only four light emitting elements 121 of one light emitting device 120 in the center were turned on in this simulation. The distance between adjacent light emitting elements 121 was 12 mm. The distance between light emitting devices 120 was 24 mm. The components of optical sheet 140 are the same as in simulation 1. The proportion of particles in light diffusion member 141 in this simulation was, for example, 0.25 wt %, 0.50 wt %, 1.0 wt %, 2.0 wt %, 3.0 wt %, 4.0 wt %, 5.0 wt %, or 10.0 wt %. The number average particle diameter of the silicone particles was, for example, 2.0 μm.

When the number average particle diameter of the particles was 1.0 μm or 2.0 μm, the investigation was made for particle proportions of 0.25 wt %, 0.5 wt %, 1.0 wt %, 2.0 wt %, 3.0 wt %, 4.0 wt %, 5.0 wt %, 6.0 wt %, 8.0 wt %, 10.0 wt %, and 12.0 wt %; however, results other than those shown below are omitted. When the number average particle diameter of the particles was 4.5 μm, the investigation was made for particle proportions of 0.25 wt %, 0.5 wt %, 1.0 wt %, 1.5 wt %, 2.0 wt %, 3.0 wt %, 5.0 wt %, 7.5 wt %, 10.0 wt %, 13.0 wt %, 15.0 wt %, 17.0 wt %, 20.0 wt %, and 30.0 wt %; however, results other than those shown below are omitted. When the number average particle diameter of the particles was 10.0 μm, the investigation was made for particle proportions of 0.25 wt %, 0.5 wt %, 1.0 wt %, 2.0 wt %, 3.0 wt %, 4.0 wt %, 5.0 wt %, 8.0 wt %, 10.0 wt %, 15.0 wt %, 18.0 wt %, 20.0 wt %, 23.0 wt %, 25.0 wt %, 27.0 wt %, and 30.0 wt %; however, results other than those shown below are omitted.

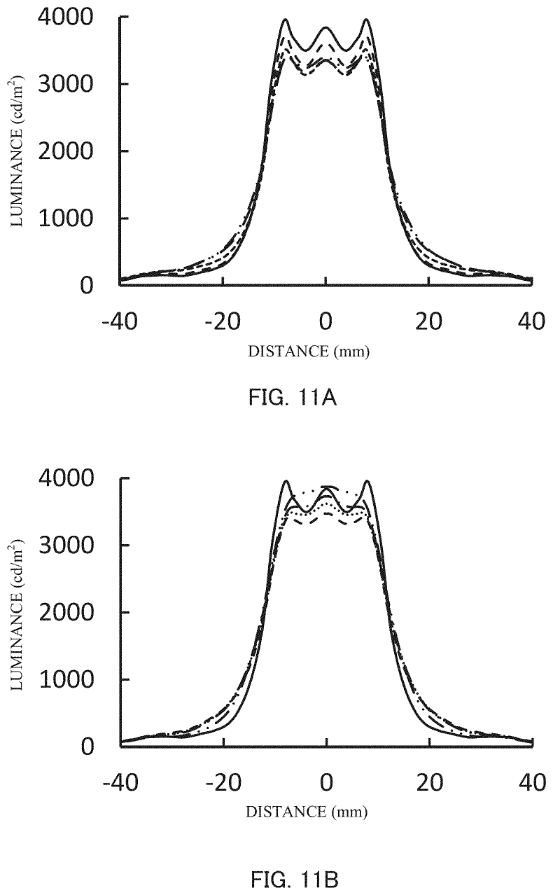

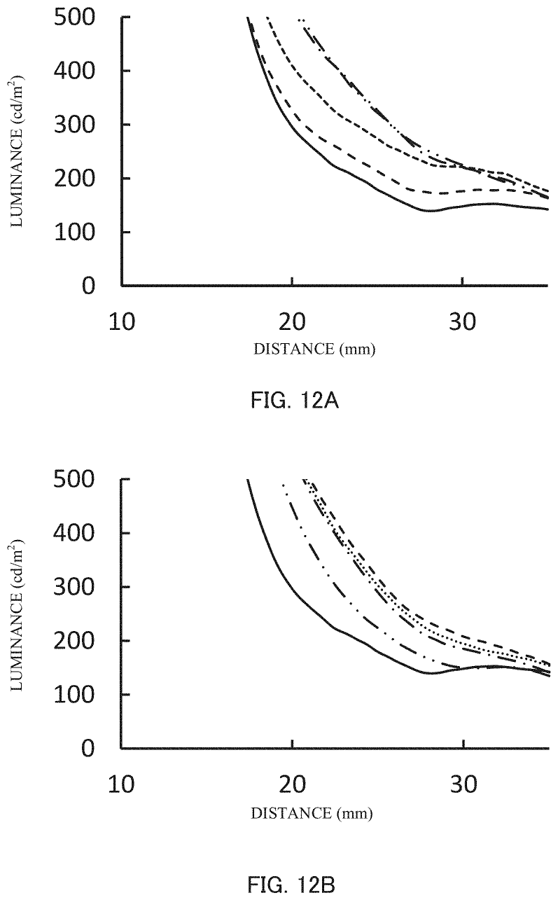

FIGS. 11A, 11B, 12A, and 12B are graphs each showing the relationship between the distance (mm) from the center of light flux controlling member 122 (light emitting device 120) and the luminance (cd/m²) on the surface of optical sheet 140. FIGS. 12A and 12B are partially enlarged views of FIGS. 11A and 11B. In FIGS. 11A and 12A, the solid line shows the result obtained by using light diffusion member 141 having a particle proportion of 0.25 wt %; the dashed line shows the result obtained by using light diffusion member 141 having a particle proportion of 0.5 wt %; the dotted line shows the result obtained by using light diffusion member 141 having a particle proportion of 1.0 wt %; the dash-dot-dash line shows the result obtained by using light diffusion member 141 having a particle proportion of 2.0 wt %; and the dash-dot-dot-dash line shows the result obtained by using light diffusion member 141 having a particle proportion of 2.5 wt %. In FIGS. 11B and 12B, the solid line shows the result obtained by using light diffusion member 141 having a particle proportion of 0.25 wt %; the dashed line shows the result obtained by using light diffusion member 141 having a particle proportion of 3.0 wt %; the dotted line shows the result obtained by using light diffusion member 141 having a particle proportion of 4.0 wt %; the dash-dot-dash line shows the result obtained by using light diffusion member 141 having a particle proportion of 5.0 wt %; and the dash-dot-dot-dash line shows the result obtained by using light diffusion member 141 having a particle proportion of 10.0 wt %. FIGS. 11A and 11B show the results of averaging in the range of −2 to +2 mm for noise reduction. In FIGS. 11A, 11B, 12A, and 12B, the abscissa represents distance (mm) from the center of light flux controlling member 122, and the ordinate represents luminance (cd/m²) on the surface of optical sheet 140.

FIGS. 11A, 11B, 12A, and 12B show that there are regions where the luminance value changes from decreasing to increasing in the vicinity of +30 mm and −30 mm from the center of light flux controlling member 122 (light emitting device 120). These regions coincide with the regions where the luminance unevenness occurs in surface light source device 100. This luminance unevenness is caused by light that is emitted from light flux controlling member 122 in the center, enters adjacent light flux controlling member 122, and is emitted.

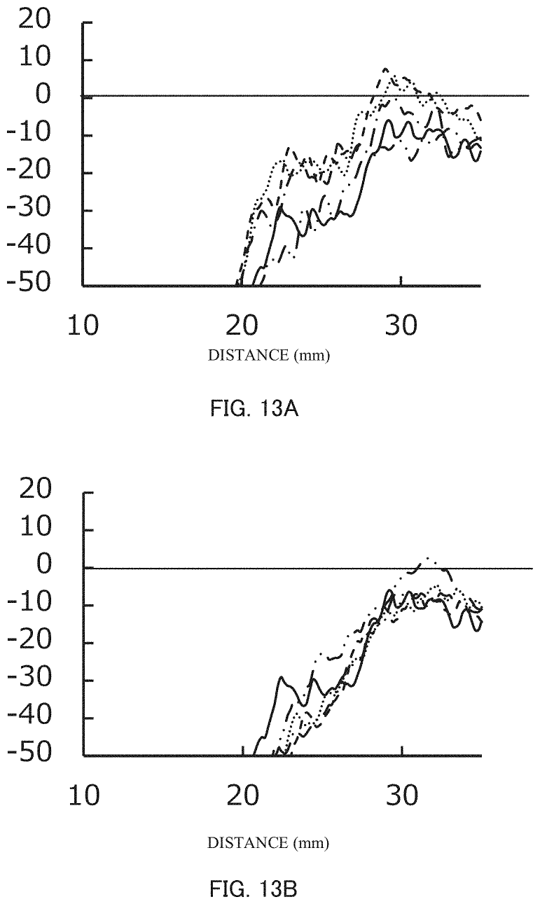

For identifying the regions where luminance unevenness occurs on optical sheet 140, graphs illustrating the curves that correspond to the first derivative of the curves illustrated in FIGS. 12A and 12B are obtained. FIGS. 13A and 13B are graphs illustrating the curves that correspond to the first derivative of the curves illustrated in FIGS. 12A and 12B. In FIG. 13A, the solid line shows the result obtained by using light diffusion member 141 having a particle proportion of 0.25 wt %; the dashed line shows the result obtained by using light diffusion member 141 having a particle proportion of 0.50 wt %; the dotted line shows the result obtained by using light diffusion member 141 having a particle proportion of 1.0 wt %; the dash-dot-dash line shows the result obtained by using light diffusion member 141 having a particle proportion of 2.0 wt %; and the dash-dot-dot-dash line shows the result obtained by using light diffusion member 141 having a particle proportion of 2.5 wt %. In FIG. 13B, the solid line shows the result obtained by using light diffusion member 141 having a particle proportion of 0.25 wt %; the dashed line shows the result obtained by using light diffusion member 141 having a particle proportion of 3.0 wt %; the dotted line shows the result obtained by using light diffusion member 141 having a particle proportion of 4.0 wt %; the dash-dot-dash line shows the result obtained by using light diffusion member 141 having a particle proportion of 5.0 wt %; and the dash-dot-dot-dash line shows the result obtained by using light diffusion member 141 having a particle proportion of 10.0 wt %. In FIGS. 13A and 13B, the abscissa represents distance (mm) from the center of the light flux controlling member, and the ordinate represents first derivative value.

As illustrated in FIGS. 12A, 12B, 13A, and 13B, first derivative value is plotted in the positive region in some curves. These regions coincide with the regions where the luminance unevenness occurs in the luminance distribution in light diffusion member 141. This luminance unevenness is caused by light that is emitted from light flux controlling member 122 in the center, enters adjacent light flux controlling member 122, and is emitted, as described above.

As illustrated in FIGS. 12A, 12B, 13A, and 13B, the luminance unevenness is related to the number average particle diameter of the particles and the proportion of the particles in light diffusion member 141.

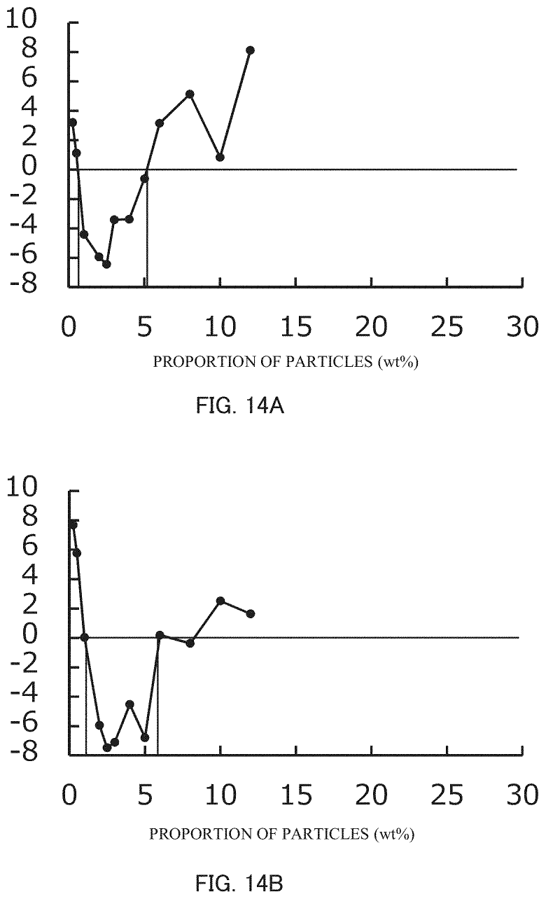

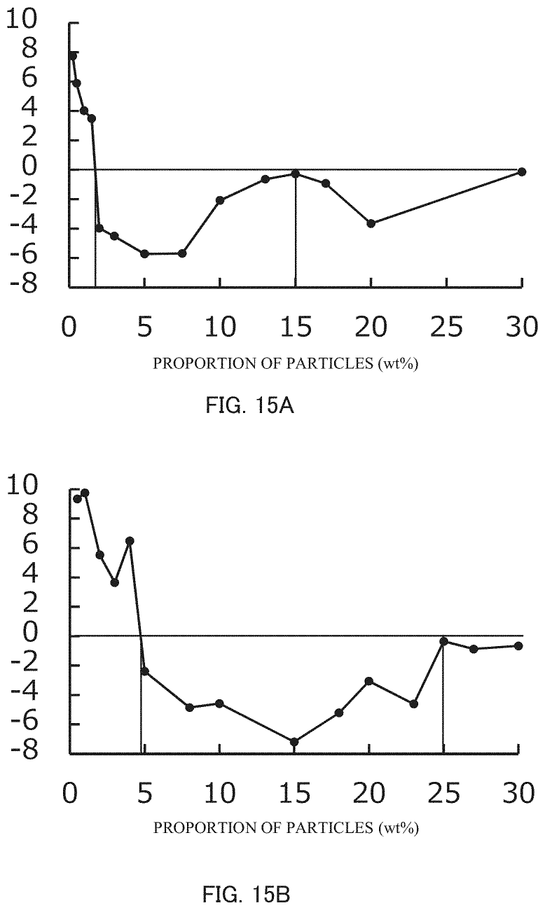

The relationship between the particle proportion (wt %) in light diffusion member 141 and the maximum value of first derivative value was then investigated for each number average particle diameter. FIGS. 14A, 14B, 15A, and 15B are graphs each showing the relationship between the particle proportion (wt %) and the maximum value of first derivative value. FIG. 14A shows the results obtained by using particles whose number average particle diameter is 1.0 μm; and FIG. 14B shows the results obtained by using particles whose number average particle diameter is 2.0 μm FIG. 15A shows the results obtained by using particles whose number average particle diameter is 4.5 μm; and FIG. 15B shows the results obtained by using particles whose number average particle diameter is 10.0 μm.

The investigation was made for the points where first derivative value changes from a negative value to a positive value and where first derivative value changes from a positive value to a negative value in FIGS. 14A, 14B, 15A, and 15B. The value at which first derivative value changes from positive to negative indicates the minimum value of the proportion of particles used for reducing the luminance unevenness during the adding of the particles to light diffusion member 141. The value at which first derivative value changes from negative to positive, meanwhile, indicates the maximum value of the proportion of particles used for reducing the luminance unevenness during the adding of the particles to light diffusion member 141. The point of 15 wt % in FIG. 15A and the point of 25 wt % in FIG. 15B are negative values, but are considered as positive in view of error.

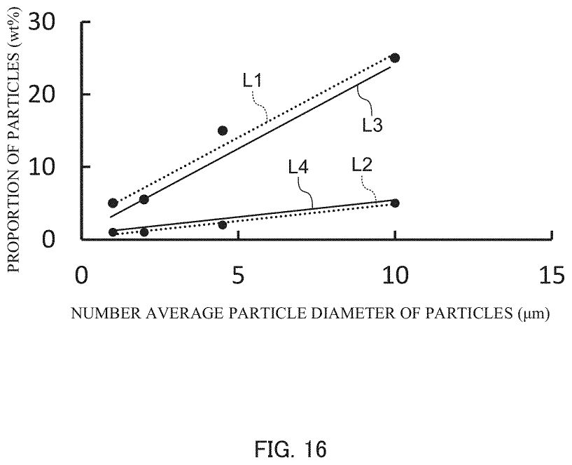

The minimum values and the maximum values (particle proportions) of the proportions of particles used for reducing the luminance unevenness illustrated in FIGS. 14A, 14B, 15A, and 15B were then plotted. FIG. 16 is a graph showing the relationship between the number average particle diameter (μm) of particles and the minimum and maximum values of the proportions (wt %) of particles used for reducing luminance unevenness. Straight line L1 illustrated in FIG. 16 is an approximate straight line obtained by the least squares method by using the maximum values of the proportions of particles used for reducing the luminance unevenness illustrated in FIGS. 14A, 14B, 15A, and 15B. Straight line L2 illustrated in FIG. 16 is an approximate straight line obtained by the least squares method by using the minimum values of the proportions of particles used for reducing the luminance unevenness illustrated in FIGS. 14A, 14B, 13A, and 15B. Straight line L1 can be represented by the formula B=2.3119A+2.5103 where the value of the number average particle diameter of the particles is A, and the value of the particle proportion is B. Similarly, straight line L2 can be represented by the formula B=0.4647A+0.2169 where the value of the number average particle diameter of the particles is A, and the value of the particle proportion is B. From the foregoing, in a range where the value A of the number average particle diameter of the particles is from 0.4 to 10.0 μm, occurrence of luminance unevenness can be prevented in the region below L1 and above L2 in FIG. 16.

In other words, satisfying Formulas 1 and 2 below can reduce luminance unevenness (where the number average particle diameter of the particles is A (μm) and the proportion of particles in light diffusion member 141 is B (wt %)).

0.4≤A≤10 Formula 1

0.4647A+0.2169≤B≤2.3119A+2.5103 Formula 2

In addition, straight line L3 that is parallel to straight line L1 and passes through the maximum value of the proportion of particles used for reducing the luminance unevenness when the average particle diameter of the particles is 2.0 μm can be represented by the formula B=2.3119A+0.8762. In addition, straight line L4 that is parallel to straight line L2 and passes through the minimum value of the proportion of particles used for reducing the luminance unevenness when the average particle diameter of the particles is 1.0 μm can be represented by the formula B=0.4647A+0.5353. From the foregoing, in a range where the value A of the number average particle diameter of the particles is from 0.4 to 10.0 μm, occurrence of luminance unevenness can be further prevented in the region below L3 and above L4 in FIG. 16. In other words, satisfying Formulas 1 and 3 below can further reduce luminance unevenness (where the number average particle diameter of the particles is A (μm) and the proportion of particles in light diffusion member 141 is B (wt %)).

0.4≤A≤10 Formula 1

0.4647A+0.5353≤B≤2.3119A+0.8762 Formula 3

Effects

In surface light source device 100 according to the present embodiment, satisfying a predetermined relationship between the number average particle diameter of particles and the proportion of particles in light diffusion member 141 can reduce luminance unevenness. This luminance unevenness is caused by light that is emitted from light flux controlling member 122 in the center, enters adjacent light flux controlling member 122, and is emitted.

### Embodiment 2

In the following, surface light source device 200 according to embodiment 2 will be described. Surface light source device 200 according to embodiment 2 is different from surface light source device 100 according to embodiment 1 only in the configuration of light flux controlling member 222 and the number of light emitting elements 121.

Configurations of Surface Light Source Device

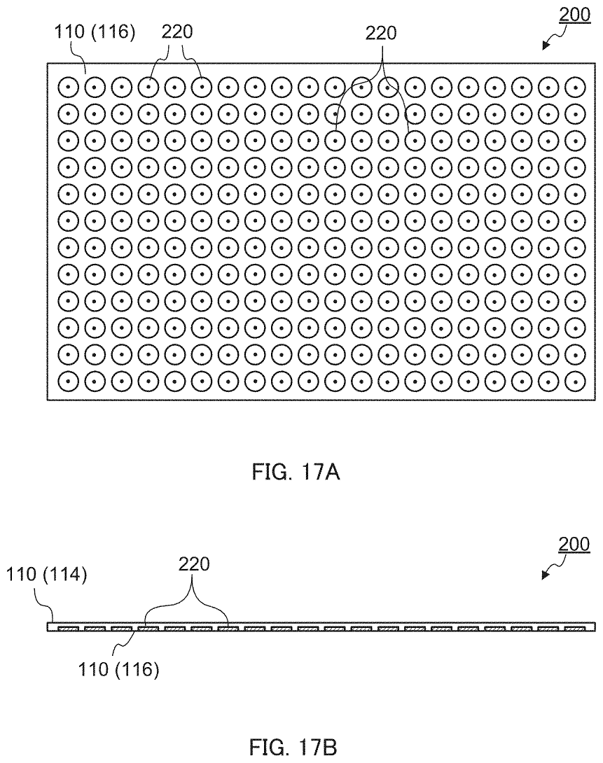

FIG. 17A is a cross-sectional view of surface light source device 200 cut in the planar direction, and FIG. 17B is a cross-sectional view of surface light source device 200 cut in the direction along its side surface.

Surface light source device 200 according to the present embodiment includes casing 110, plurality of light emitting devices 220, and optical sheet 140 (not lustrated) which includes light diffusion member 141. Each light emitting device 220 includes one light emitting element 121 and one light flux controlling member 222. Light flux controlling member 222 has a circular shape in plan view in the present embodiment, thus distance H between the front surface of substrate 116 and the back surface of light diffusion member 141 is preferably 3 to 10 mm

Configuration of Light Flux Controlling Member

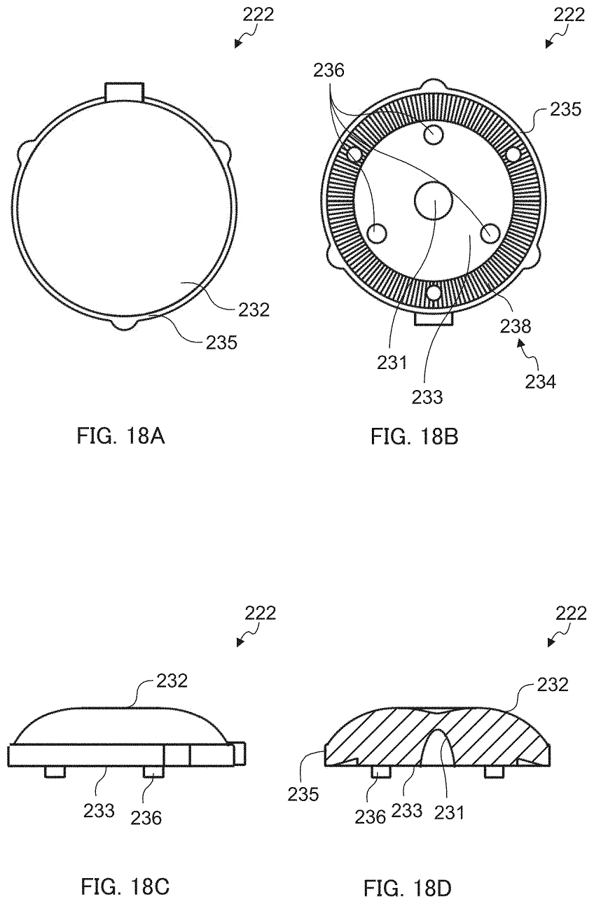

FIGS. 18A to 18D illustrate a configuration of light flux controlling member 222 in embodiment 2 of the present invention. FIG. 18A is a plan view of light flux controlling member 222. FIG. 18B is a bottom view of the light flux controlling member. FIG. 18C is a right side view of the light flux controlling member. FIG. 18D is a cross-sectional view taken along line A-A of FIG. 16A.

As illustrated in FIGS. 18A to 18D, light flux controlling member 222 includes incidence surface 231, emission surface 232, back surface 233, annular recess 234, flange 235, and plurality of legs 236. Light flux controlling member 222 of the present embodiment has a substantially circular shape in plan view.

Incidence surface 231 allows the majority of light emitted from light emitting element 121 to enter light flux controlling member 222, while controlling the travelling direction of the light. In the present embodiment, incidence surface 231 is an inner surface of a recess disposed on the back surface of light flux controlling member 222. Incidence surface 231 intersects the central axis of light flux controlling member 222 and is rotationally symmetric (circular symmetric) about the central axis. The recess may have any shape, and may have a shape of, for example, half an elongated sphere (a shape obtained by dividing a spheroid, obtained with the major axis of an ellipse as the axis of rotation, into two along the minor axis).

Emission surface 232 emits the light having entered light flux controlling member 222 to the outside while controlling the travelling direction of the light. Emission surface 232 is formed on the front side (light diffusion member 141 side) of light flux control member 222 so as to project from flange 235. Emission surface 232 is rotationally symmetric (circular symmetric) about central axis CA. In the present embodiment, emission surface 232 includes a central portion that is a smoothly curved surface concave toward light emitting element 121 and an outer edge portion that is a smoothly curved surface convex with respect to light diffusion member 141.

Back surface 233 is a flat surface located on the back side of light flux controlling member 222 and extending radially from the opening edge of incidence surface 231. Annular recess 234 having a ring shape is disposed on the outer peripheral portion of back surface 233.

Annular recess 234 is located on the outer peripheral portion of back surface 233 and laterally reflects the light internally reflected by emission surface 232. Annular recess 234 includes plurality of second linear protrusions 238. Plurality of second linear protrusions 238 are disposed in a direction radially from the center of light flux controlling member 222 when light flux controlling member 222 is viewed from the bottom.

Flange 235 is located between the outer peripheral portion of emission surface 232 and the outer peripheral portion of back surface 233, and projects outward in the radial direction. Flange 235 substantially has a shape of a ring. Flange 235 is not an essential component, but the presence of flange 235 allows easy handling and positioning of the light flux controlling member 222.

Plurality of legs 236 are substantially columnar members projecting from back surface 233. Plurality of legs 236 support light flux controlling member 222 at an appropriate position with respect to light emitting element 121.

In the surface light source device of the present embodiment as in embodiment 1, when the number average particle diameter of particles contained in light diffusion member 141 is A (μm) and the proportion of the particles in light diffusion member 141 is B (wt %), the following Formulas 1 and 2 are satisfied.

0.4≤A≤10 Formula 1

0.4647A+0.2169≤B≤2.3119A+2.5103 Formula 2

Simulation 3

In this simulation, the following light diffusion member was used as light diffusion member 141: light diffusion member 141 containing 2.0 wt % of silicone particles having a number average particle diameter of 2 μm in the light diffusion member, or light diffusion member 141 containing 4.0 wt % of silicone particles having a number average particle diameter of 4 μm in the light diffusion member. Each light diffusion member 141 has a thickness of 2 mm. The diameter of light flux controlling member 222 is 9.0 mm. In this simulation, surface light source device 200 including light flux controlling member 222 according to the present embodiment in place of light flux controlling member 122 in FIG. 6 was used. The distance between the centers of gravity of light emitting devices 220 in the X direction of FIG. 6 is 23 mm, and distance P between the centers of gravity of light emitting devices 220 in the Y direction of FIG. 6 is also 23 mm. In addition, distance H between substrate 116 and light diffusing member 141 is 5 mm, 6 mm, 7 mm, 8 mm, 9 mm, or 10 mm. As optical sheet 140, the following were used: each light diffusion member 141 described above, quantum dot sheet 142, first prism sheet 143 (BEFIII from 3M Japan Limited), second prism sheet 144 (BEFIII from 3M Japan Limited), and dual brightness enhancement film (DBEF) 450. Light diffusion member 141 containing 2.0 wt % of silicone particles having a number average particle diameter of 2 μm in light diffusion member 141, and light diffusion member 141 containing 4.0 wt % of silicone particles having a number average particle diameter of 4 μm in light diffusion member 141 satisfy the above Formulas 1 and 2.

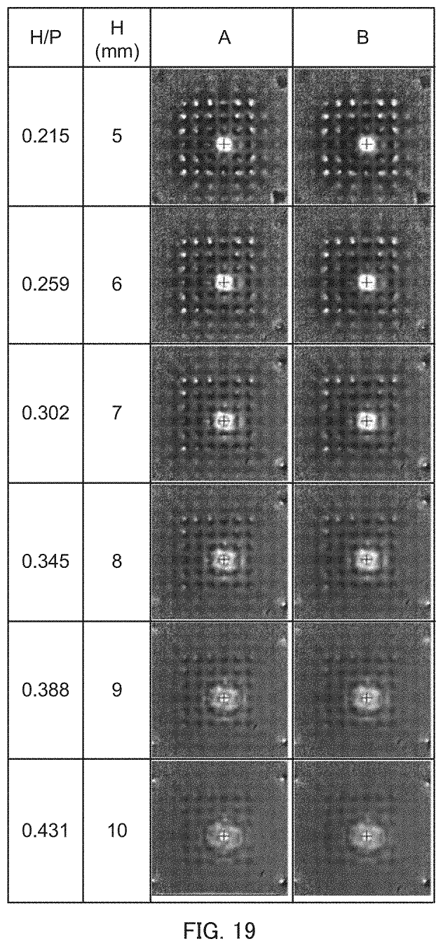

FIG. 19 is a table for explaining the relationship between the luminance distribution and the distance from a substrate to a light diffusion member with respect to the distance between the centers of gravity of light emitting devices 120. Column H/P in FIG. 19 shows the ratio of distance H—distance between substrate 116 and optical sheet 140—with respect to distance P—distance between the centers of gravity of light emitting devices 120. Column H in FIG. 19 shows distance H (mm) between substrate 116 and optical sheet 140.

Column A in FIG. 19 shows the results obtained by using light diffusion member 141 containing 4.0 wt % of silicone particles having a number average particle diameter of 4 μm in the light diffusion member. Column B in FIG. 19 shows the results obtained by using light diffusion member 141 containing 2.0 wt % of silicone particles having a number average particle diameter of 2 μm in the light diffusion member.

FIG. 19 shows that luminance unevenness can be reduced to some extent regardless of the relationship between distance P between the centers of gravity of light emitting devices 120 and distance H between substrate 116 and optical sheet 140. In particular, when H/P≥0.345, luminance unevenness can be remarkably reduced. Therefore, when the distance between the centers of gravity of light emitting devices 120 is distance P and the distance between substrate 116 and optical sheet 140 is distance H, satisfying the following Formula 5 is preferred.

H/P≥0.35 Formula 5

Effects

As described above, the surface light source device according to the present embodiment has the same effect as surface light source device 100 according to embodiment 1.

### INDUSTRIAL APPLICABILITY

The surface light source device according to the present invention can be applied to, for example, a backlight of a liquid crystal display device and general-purpose lighting.

### REFERENCE SIGNS LIST

100, 200 Surface light source device
100′ Display device
102 Display member
110 Casing
112 Bottom plate
114 Top plate
116 Substrate
120 Light emitting device
121 Light emitting element
122, 222 Light flux controlling member
123 Incidence unit
124 Emission unit
125 First emission unit
126 Second emission unit
131, 231 Incidence surface
132 Reflection surface
133 First emission surface
134 Second emission surface
135 Third emission surface
136 Fourth emission surface
140 Optical sheet
141 Light diffusion member
141a Linear protrusion
141b Protrusion
141c Recess
142 Quantum dot sheet
143 First prism sheet
144 Second prism sheet
145 Dual brightness enhancement film
231 Incidence surface
232 Emission surface
233 Back surface
234 Annular recess
235 Flange
236 Leg
238 Second linear protrusion
CA Central axis
OA Optical axis

What is claimed is:

1. A surface light source device, comprising:
a plurality of light emitting devices each including one or more light emitting elements and a light flux controlling member for controlling a distribution of light emitted from the one or more light emitting elements; and
an optical sheet including a light diffusion member that includes particles having an optical transparency, the light diffusion member being for transmitting light emitted from the plurality of light emitting devices while diffusing the light,
wherein
when a number average particle diameter of the particles is A (μm) and a proportion of the particles in the light diffusion member is B (wt %), the surface light source device satisfies Formulas 1 and 2 below
0.4≤A≤10 Formula 1, and
0.4647A+0.2169≤B≤2.3119A+2.5103 Formula 2.

2. The surface light source device according to claim 1, wherein:
the surface light source device further satisfies Formula 3 below
0.4647A+0.5353≤B≤2.3119A+0.8762 Formula 3.

3. The surface light source device according to claim 1, wherein the particles include silicone particles.

4. The surface light source device according to claim 1, wherein:
the light diffusion member includes a plurality of protrusions or a plurality of recesses on a surface facing the plurality of light emitting devices.

5. The surface light source device according to claim 1, wherein:
each of the plurality of light emitting devices includes
a plurality of the one or more light emitting elements, and
the light flux controlling member for controlling the distribution of the light emitted from the plurality of light emitting elements.

6. The surface light source device according to claim 1, wherein:
each of the plurality of light emitting devices includes
one of the one or more light emitting elements, and
the light flux controlling member for controlling the distribution of the light emitted from the light emitting element.

7. The surface light source device according to claim 5, wherein:
when a distance between centers of gravity of two adjacent light emitting devices among the plurality of light emitting devices in plan view is P, and a distance between the light diffusion member and a substrate on which the plurality of light emitting devices are disposed is H, the surface light source device satisfies Formula 4 below
0.08≤H/P≤0.22 Formula 4.

8. The surface light source device according to claim 6, wherein:
when a distance between centers of gravity of two adjacent light emitting devices among the plurality of light emitting devices in plan view is P, and a distance between the light diffusion member and a substrate on which the plurality of light emitting devices are disposed is H, the surface light source device satisfies Formula 5 below
H/P≥0.35 Formula 5.

9. A display device, comprising:
the surface light source device according to claim 1; and
a display member to be illuminated with light emitted from the surface light source device.
